(19) United States
(12) Patent Application Publication
(10) Pub. No.: US 2004/0126282 A1
(43) Pub. Date: Jul. 1, 2004

(54) Sample container, measuring device and method for X-ray analysis of liquids

(76) Inventor: Waltherus W. Van Den Hoogenhof, Almelo (NL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/658,249

(22) Filed: Sep. 8, 2003

Related U.S. Application Data
(63) Continuation-in-part of application No. PCT/IB02/00701, filed on Mar. 5, 2002.

(30) Foreign Application Priority Data
Mar. 13, 2001 (EP) 01200937.9

(51) Int. Cl. B01L 3/00

(52) U.S. Cl. 422/102

(57) ABSTRACT

The partial evaporation of the sample liquid during X-ray analysis of liquids gives rise to problems, since the quantity of the sample liquid does not remain constant and evaporated gas is liable to invade the measuring paths in which it may lead to measurement falsifications. In order to solve this problem, there is provided a sample container for receiving a sample liquid, which container leaves open an opening at its top, and a cover is placed on the free surface of the sample liquid. The cover is not rigidly connected to the wall of the sample container and, therefore, allows pressure equalization. Evaporation phenomena are almost completely precluded as a result of the covering of the liquid surface.

### FIELD OF INVENTION

The invention relates to a method for the analysis of liquids by means of X-ray spectrometry, in which method a liquid sample is introduced into a sample container provided with an opening at its top, the sample container is positioned in a sample holder and the liquid sample is analyzed. The invention also relates to a corresponding measuring device as well as to a sample container in conformity with the introductory part of claim 1 and used to carry out the method.

### BACKGROUND TO THE INVENTION

In practical X-ray analysis use is made of known sample containers in which liquid samples can be introduced so as to be examined via a zone of the container wall which is transparent to X-rays, said zone usually being the very thin bottom of the container. A problematic aspect of such analyses is that, due to the evaporation of the sample liquid, the quantity of sample does not remain constant during the measurement. Moreover, the evaporated gas components are liable to invade the optical path between the sample and the X-ray source or the detector, thus falsifying the results. Therefore, it would be desirable to use completely closed sample containers. Unfortunately, such sample containers cannot be used for such measurements, because the measurements usually must be performed under reduced pressure, so that container an excess pressure relative to the surroundings would arise in a closed sample container. This would lead to destruction of the sample container, because the walls thereof must at least locally be constructed so as to be extremely thin for X-ray analysis, so that they break already in the case of very small pressure differences.

U.S. Pat. No. 5,351,281 discloses a sample container in which the opening at the top is closed by means of a microporous film which prevents the escape of possibly undesirable substances of the sample from the container, but still allows a gas exchange so that the pressure differences capable of destroying the container cannot occur between the sample and the surroundings. However, containers of this kind do not prevent the evaporation of sample material and, therefore, are not very well suitable either for the analysis of very volatile liquid samples in particular.

### SUMMARY OF THE INVENTION

The invention relates to a sample container for the X-ray analysis of liquids, which container comprises a container wall which forms a cavity for receiving a liquid sample, the container wall being constructed so as to be at least locally transparent to X-rays and leaving open an opening at the top; and a cover which is to be arranged on the free surface of the liquid sample and is not rigidly connected to the container wall.

The invention also relates to a method for the X-ray analysis of liquids, and a corresponding measuring device.

The method, device and container enable a reduction of the evaporation of sample material and also the execution of measurements at different pressures out without giving rise to destruction.

### BRIEF DESCRIPTION OF THE DRAWING

FIG. 1 shows a schematic of an embodiment of the invention.

### DETAILED DESCRIPTION

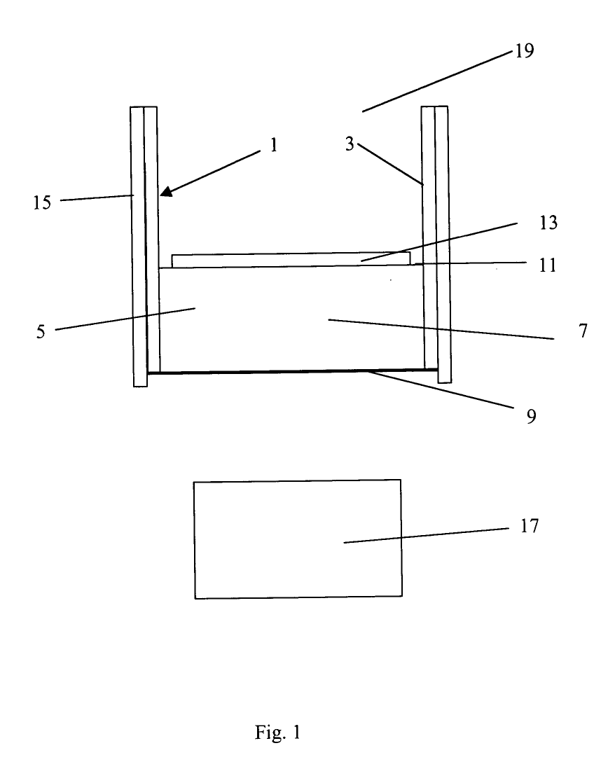

As shown in FIG. 1, the sample container 1 includes a container wall 3 defining a cavity 5 for receiving a liquid sample 7 and further defining an opening 19. The container wall 3 of the sample container 1 is at least locally transparent to X-rays in region 9. The liquid sample 7 has a free surface 11 and a cover 13 rests on the free surface and is not rigidly connected to the container wall 3.

Because of the use of a cover 13 which is arranged on the free surface 11 of the liquid sample 7 in the sample container 1, no convection from the liquid surface takes place in this area so that evaporation is reduced to a high degree. This holds notably when the cover is constructed so as to be impervious to gas.

Because the cover 13 preferably covers essentially the entire free surface 11 of the liquid sample 7, and hence is only slightly smaller than the top opening 19 of the container wall, and is not rigidly connected to the container wall 3, pressure differences can be equalized without giving rise to excess pressures or reduced pressures in the sample container and hence to tears. Preferably, use is made of a cover 13 which has a diameter slightly smaller than that of the container opening and is freely movable relative to the container wall 3. However, a cover 13 which corresponds approximately to the container opening and is attached to the container wall 3 is also feasible when it is flexible and has a small opening for pressure equalization.

In order to ensure that the entire liquid sample 7 is available for the measurement and that the quantity of sample does not change, the cover 13 should not be absorbent, that is, it should not absorb sample material. From a manufacturing point of view it is advantageous to form the cover 13 as a foil which preferably consists of a synthetic material such as polypropylene. However, the cover may also be formed as a sheet, as a cushion or as a foam.

FIG. 1 also shows a sample holder 15 and an X-ray spectrometer 17.

Evaporation can be precluded practically completely by covering the liquid sample by means of a cover in accordance with the invention. The X-ray analyses then performed are much more accurate and faster. Even when evaporation cannot be precluded one hundred percent, the evaporation gas remains at least substantially under the cover and hence does not reach the surroundings, notably the measuring paths.

The development in accordance with the invention, therefore, enables significant improvement of X-ray analysis of liquids. Moreover, the sample containers in accordance with the invention can be manufactured in a rather uncomplicated and hence extremely economical fashion.

In the claims

1. A sample container for the X-ray analysis of liquids, which container comprises:
a container wall which defines a cavity for receiving a liquid sample, the container wall being constructed so as to be at least locally transparent to X-rays and leaving open an opening at the top; and
a cover which is to be arranged on the free surface of the liquid sample and is not rigidly connected to the container wall.

2. A sample container as claimed in claim 1, wherein the cover is at least essentially impervious to gas.

3. A sample container as claimed in claim 1, wherein the cover is not absorbent.

4. A sample container as claimed in claim 1, wherein the cover is a foil.

5. A sample container as claimed in claim 1, wherein the cover comprises a polypropylene material.

6. A sample container as claimed in claim 1, wherein the cover is smaller than the opening at the top of the container wall.

7. A measuring device comprising:
a sample container for the X-ray analysis of liquids, which container comprises a container wall which forms a cavity for receiving a liquid sample, the container wall being constructed so as to be at least locally transparent to X-rays and leaving open an opening at the top, and cover which for arrangement on the free surface of the liquid sample and not rigidly connected to the container wall; and
an X-ray spectrometer for the analysis of a liquid sample accommodated in the sample container.

8. A method for the analysis of liquids by means of X-ray spectrometry, in which method a liquid sample is introduced into a sample container comprising a container wall which leaves open an opening at the top, the sample container is positioned in a sample holder and the liquid sample is analyzed, wherein prior to the analysis a cover which is freely movable relative to the container walls is provided on the free surface of the liquid sample.

9. A method as claimed in claim 8, wherein the sample holder is a sample container for the X-ray analysis of liquids, which container comprises a container wall which forms a cavity for receiving a liquid sample, the container wall being constructed so as to be at least locally transparent to X-rays and leaving open an opening at the top, and cover which for arrangement on the free surface of the liquid sample and not rigidly connected to the container wall
